(19) United States
(12) Patent Application Publication
(10) Pub. No.: US 2007/0174615 A1
(43) Pub. Date: Jul. 26, 2007

(54) Method and device for communication using random codes

(75) Inventors: Bernard L. Ballou JR., Raleigh, NC (US); Charles Eric Hunter, Jefferson, NC (US); Timothy Richard Crocker, Cockwood (GB)

Correspondence Address: Steven Fischman;Scully, Scott, Murphy & Presser, P.C., Suite 300, 400 Garden City Plaza, Garden City, NY, 11530, US

(73) Assignee: LastMile Communications Limited, Devon (GB)

(21) Appl. No.: 11/401,574

(22) Filed: Apr. 11, 2006

(30) Foreign Application Priority Data
Apr. 11, 2005 (EP) EP 0 5252250.5

(51) Int. Cl. H04L 9/00

(52) U.S. Cl. 713/168

(57) ABSTRACT

A method and device for communication, in which a random code is used in the communication. The method comprises storing a random code in a first device; storing the random code in a second device; and using the random code in a subsequent communication. The invention may be employed in a financial transaction. That is, the random codes may be used either as keys to endorse payment instructions with a digital signature; or as “virtual cash”, in which case the codes themselves are transmitted between the parties. Another application of the invention is in transferring confidential information by a “one time pad” security technique, in which a random list of numbers is used to encode the character code for a symbol, by a simple numerical operation.

The present invention relates to a method and device for communication, in which a random code is used in the communication. The communication may be, for example, part of a financial transaction, or any other confidential communication.

A first aspect of the invention provides a method of communication comprising storing a random code in a first device; storing the random code in a second device; and using the random code in a subsequent communication.

The invention also provides a device comprising a memory for storing a random code; and a processor for utilizing the random code in a subsequent communication.

The random code may be either transmitted in the subsequent communication, or used as an encoding key in the subsequent communication.

For instance the subsequent communication may comprises part of a financial transaction. That is, the random codes may be used either as keys to endorse payment instructions with a digital signature; or as “virtual cash”, in which case the codes themselves are transmitted between the parties.

Another application of the invention is in transferring confidential information by a “one time pad” security technique, in which a random list of numbers is used to encode the character code for a symbol, by a simple numerical operation. A receiver armed with the same list can reverse the encoding and can thus recover the document. If, by way of example, the original is available in the familiar ASCII computer code, and the list of random numbers are each of a byte, in this case taken to represent the numbers 0-255, then the encoding process can be addition modulo 256 of the 8 bit ASCII code and the 8 bit unsigned random number, and the reverse operation is just subtraction modulo 256.

Clearly matching lists of random 8 bit unsigned numbers (bytes) can be interpreted as single bytes for the purposes of secure communications, or in longer sequences (typically 16 bytes) for monetary, authentication or transaction verification purposes.

It would of course be possible to generate the random codes on a conventional computer, and to make two copies onto a storage medium such as a CD. This approach however has a number of problems:
Computers are subject to ‘hacking’ and the confidentiality of the two copies of the list may be compromised if someone is running an illegal program on the computer that can ‘spy’ and transfer a third copy of the list to a third party. This third party would be able to decode any documents or files that had been securely encoded, without the knowledge of the two ‘proper’ users, and alternatively to make payments using any monetarily encoded parts of a list.
Recording media such as CDs can be read after they have been generated, without leaving any trace of that reading. Therefore physical access to the CD (theft) to make a copy, would allow the same improper access as outlined above: if the CD is replaced where it was stolen from then the legitimate user has no knowledge.

The various embodiments of the invention described below present various security measures which aim to overcome these problems, as will now be described with reference to the accompanying drawings, in which:

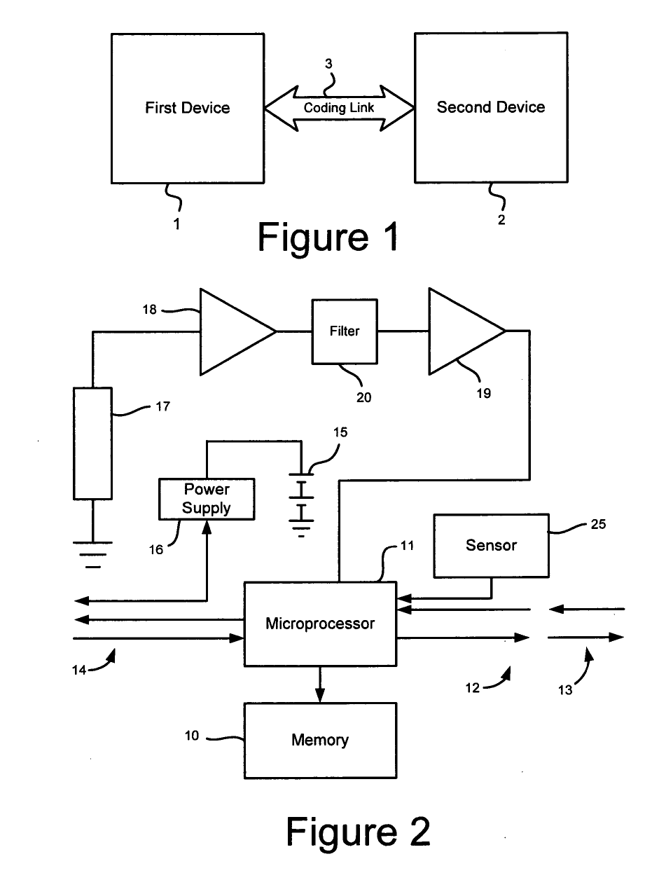

FIG. 1 shows a pair of devices;

FIG. 2 shows one of the devices in detail;

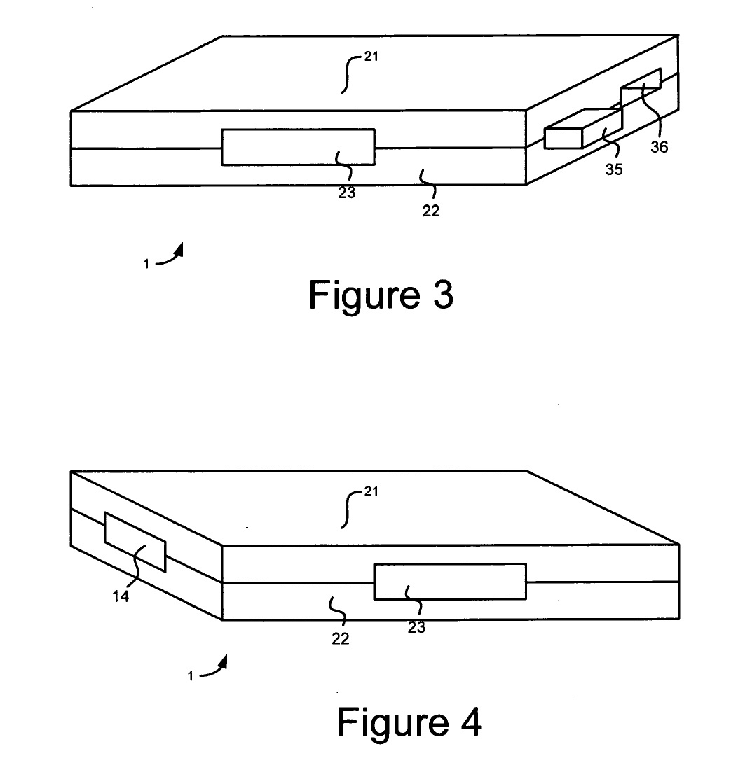

FIG. 3 is a schematic view of one of the devices taken from the left-hand side;

FIG. 4 is a schematic view of one of the devices taken from the right-hand side;

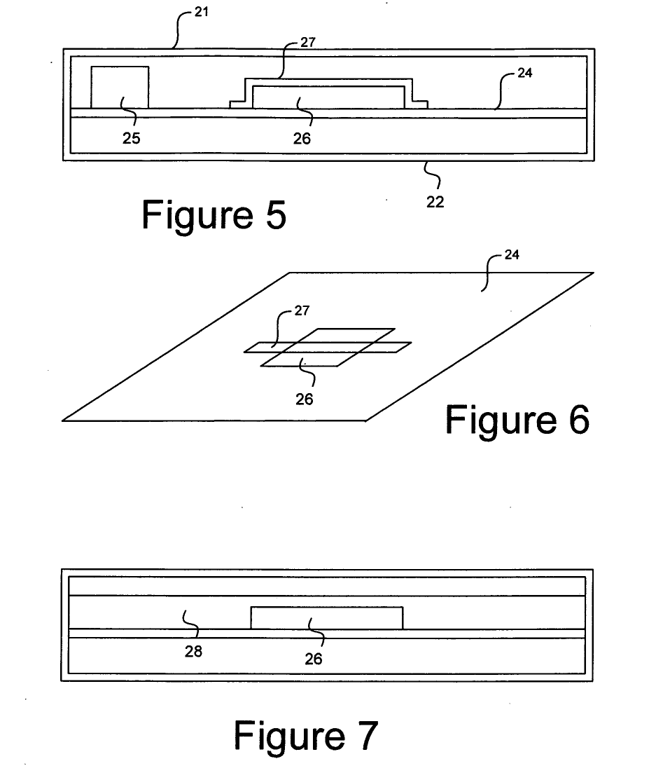

FIG. 5 is a schematic cross-section taken through the device;

FIG. 6 show the PCB, chip and security strip;

FIG. 7 is a schematic cross-section taken through an alternative device;

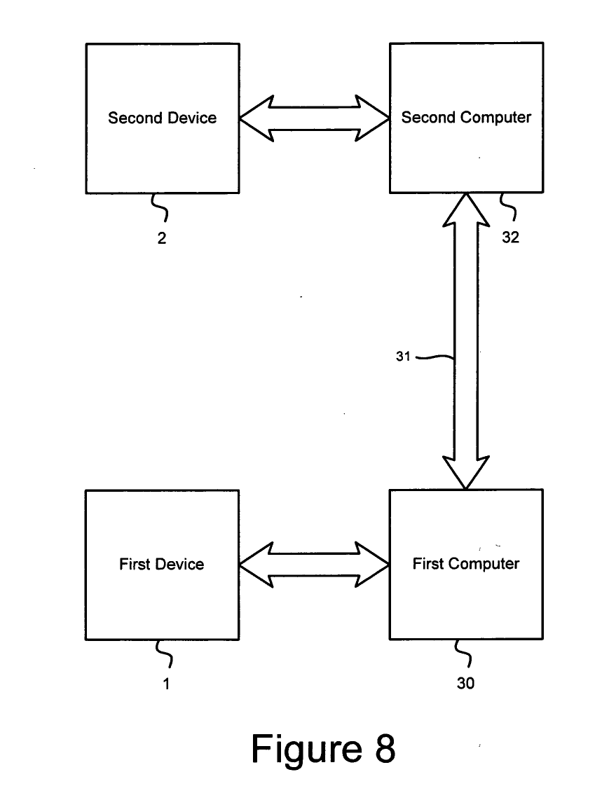

FIG. 8 shows the use of the devices in a “one time pad” secure communication;

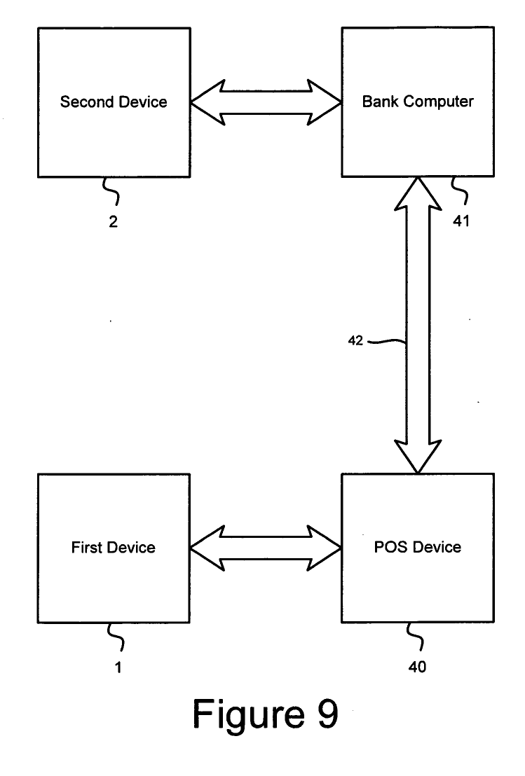

FIG. 9 shows the use of the devices in a financial transaction; and

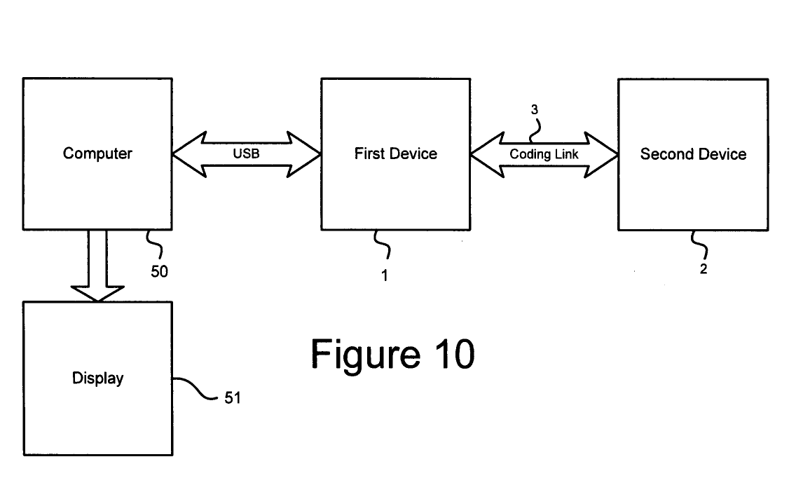

FIG. 10 shows an alternative arrangement for the devices during code generation.

### DESCRIPTION OF PREFERRED EMBODIMENTS OF THE INVENTION

FIG. 1 shows a first device 1 connected to a second device 2 via a coding link 3. FIG. 2 illustrates the functional components of the first device 1 in schematic form. The second device 2 is identical.

Device Hardware

Referring to FIG. 2, the device 1 has non-volatile storage 10, such as FLASH memory, and one or more microprocessors or micro-controllers 11.

The coding link 3 is established by connecting together the coding port 12 of the first device 1 with the coding port 13 of the second device 2. The coding ports 12, 13 each have hermaphrodite connectors, such as half male pins and half female sockets, so that every device can plug into any other.

The device also has a USB or similar port 14 coupled to the microprocessor 11, a set of rechargeable battery cells 15 and a power supply circuit 16. A resistor 17 (or other noise generating device such as a radioactive source) generates a noise signal which is fed to an amplifier 18 and a comparator 19, which produces a digital bit stream which is fed to the microprocessor 11. A filter 20 ensures that the bandwidth of the noise signal arriving at the comparator is such that it changes relatively often compared to the bit stream being clocked out, but that the action of the clocking latch is very quick. The USB port 14 is also connected to the microprocessor 11, and electrical power taken from the USB port 14 is also fed via the power supply circuit 16 to the rechargeable cells 15. At any time that the USB port 14 is connected to a live USB port, operation would be from the USB supply and the cells 15 would be charged.

Code Table Generation

In order to generate code tables, the devices 1, 2 are plugged together by the hermaphrodite coding ports 12, 13, with electrical power coming from the rechargeable cells. The connection via the coding ports is recognized, and both devices enter a period of communication with the other to establish what procedures are allowed.

Thus when the two devices are connected together, and following an authorization phase as described below, and if this results in approval status, they can start to generate code tables in pairs.

The microprocessor 11 connects to the memory 10 by one of the two following alternative methods, depending on whether there is a parallel or serial interface.

In the case of a parallel interface, the microprocessor 11 generates an address bus that is an input to the memory 10, selecting which byte or word of memory is to be accessed, and a data bus, which might be 8 bits (byte) or 16 bits (word) wide. The data bus can be used either to supply a byte or word of data to the memory to be written, or it may receive a byte or word stored having previously set up the bus and manipulated the read and output control lines, which are also driven by the microprocessor.

In the case of a serial interface, such as the SPI standard, or the I2C standard, data is sent serially, with a clock. In SPI each memory device needs the microprocessor 11 to generate for it a ‘Chip Enable’ signal, so that if several memory devices share the bus connection, only one is enabled and active at a time. In I2C, the address of a device is set by selecting logic highs and lows on its address pins (so that an individual device ‘knows’ its address) and address selection to set an active device is by address selection encoding sent on the serial interface.

The two methods described above apply where the memory 10 is a FLASH memory device. There are many other detailed variations on this scheme, and many other non-volatile memory types. In all of them, the physical devices are considered to be part of a memory ‘map’ where there is a valid address range (or ranges if the memory addressing is not contiguous) which is coded within the microprocessor 11, or which it can find by trial writing and reading in its memory range.

Each device in a pair has some memory, preferably, but not necessarily, the same amount. The memory size in current devices might be up to a few Gigabytes, and future devices may provide more. Even a few tens of kilobytes (far less than the smallest current memory devices) would be useful.

Each microprocessor 11 stores one or more memory pointers. These memory pointers are values held in registers when the device is active, and held in the non-volatile memory 10 when there is no power. Conveniently the device might reserve the top of the memory IO to store the memory pointers.

Consider the situation where the devices are new, and no security codes have been generated. It is therefore necessary to write to all of the memory space in each device (or up the limit of the smaller capacity device).

In operation, a ‘handshaking’ operation in communications across the coding link 3 establishes that both devices are ready to proceed and sets memory pointers in both devices to point at the bottom of the memory 10. Each device now set its noise generator 17 and comparator 19 running, and clocks this bit stream into registers to make bytes or words that are written to memory 10.

Identical copies of the codes need to be written, meaning that the bit streams need to be combined in some way, so that both devices have an identical copy at a particular address location. There are innumerable ways of doing this: the combination can not only be at a byte or word level, but in blocks, or across the whole address space if a pattern or algorithm is included in each device.

involved, and there are no connections to the outside world, or other processes running within the devices that would allow a third copy to be made, providing that the code generation operation is properly monitored and controlled by an individual taking responsibility for his/her actions. Good ‘electromagnetic’ screening is provided so that stray electromagnetic radiation from the action of the devices is so low that non-contact ‘eavesdropping’ is difficult or impossible.

Coding Security Measures

Identity Check

Each device has as part of a program or calibration code in the microprocessor 11 its own unique identifier code, and some other codes setting out what it is allowed to do. In the most secure embodiment, the devices are manufactured in pairs, and so they also carry ‘hard coded’ in the microprocessor 11 (most securely using a ‘one time’ calibration write sequence at the time of manufacture of the device that is irreversible) the identity of their pair device. This enables the devices to check each other's identity, and if they did not match then the program in each microprocessor would be such as to shut down further operation. This identity checking procedure could be made secure: for instance there might be a ‘public’ part of the code, which would be a very large number that the device was free to reveal to identify itself. There could then also be a further hidden code or codes which the devices would compare, taking turns, swapping bit by bit and comparing the received bit with the copy they are expecting. If at any swap they do not receive the bit they expect then they shutdown and reveal nothing more (such a procedure makes it certain to a very high statistical level that the shutdown would occur before very much of the code was revealed). Only in the circumstance that both halves of a pair are brought together would the whole code be swapped. Other such procedures are possible.

Physical Security Features

There is however always the possibility of breach of security by human intervention. At one level someone having physical access inside one of the devices 1, 2 can always physically remove the memory 10 and read them without the other preventative measures (described below) coming into operation. So at a physical level, each device 1, 2 has a tamper-evident element (such as a foil high security strips) and is also made tamper-proof (for instance by physical bonding) as described below.

FIGS. 3 and 4 are schematic views taken from the left and right-hand sides of one of the devices 1. The device comprises a casing formed in an upper half 21 and a lower half 22. A plug 35 and socket 35 (which together constitute the hermaphrodite coding port 12) are shown schematically in FIG. 3, and USB port 14 is shown in FIG. 4. The casing halves are formed from injection molded plastics, or high precision metal castings. If broken it is virtually impossible to re-make the casing without that being obvious. Therefore, to a high degree of security it is obvious by inspection whether a casing has been physically damaged to gain access. The casing halves are held together by screws or clips (not shown) to allow access to the interior of the device for repairs or servicing. High security tape strips 23 (which may, for example, comprise metalised plastic film with embossed holographic patterns) are taped across the joint between the two casing halves on the left and right-hand side of the casing. The strips are adhered using adhesive which will require the strip to tear rather than become un-adhered to the body. The combination of the certainty of ripping and the uniqueness of the patterning make it very nearly impossible for someone to breach the strips 23 without them being detected.

An alternative or additional feature is to add something actively electronic. It is for instance relatively simple to incorporate switches or sensors (either physical, or optical, or magnetic) which detect that the case is being opened. As shown in FIG. 5, which is a schematic cross-section taken through the device, a printed circuit board (PCB) 24 carries a sensor 25 (also shown in FIG. 2) which senses when the device has been opened, and causes the microprocessor 11 to set a flag which can subsequently inform the user of such opening, and which optionally might destroy or scramble the codes or pointers.

Increasingly, modem electronics packaging itself provides a very considerable degree of ‘difficulty’ to a person attempting to gain access. Skilled people can remove even small outline conventional packages. However, Ball Grid Array devices require very specialist equipment, and indeed some package types might be effectively impossible to remove, even by specialists. At the extreme, devices can be bonded to the printed circuit board or substrate at the chip level, using gold bond wires. Therefore in the preferred example of FIG. 5, the microprocessor 11 (and optionally some of the other electronic components of FIG. 2) is implemented in a Ball Grid Array technology or at chip level 26 bonded to the PCB 24 using gold wires (not shown).

A final and probably most useful element of security is to make the upper half 21 (and optionally also the lower half 22) of the casing out of optically transparent plastic, or with a window of same positioned over the chip 26. As shown in FIGS. 5 and 6, a foil strip 27 with a security pattern is adhered in place over the PCB 24 and chip 26. Thus physical tampering would be obvious by the irreparable damage to the strip 27.

In the alternative embodiment of FIG. 7 the chip 26 is embedded in a resin layer 28 with a security pattern or stamp (not shown). Any physical tampering with the board itself would be obvious by the irreparable damage to the security pattern or stamp.

Maps

There is a further possibility that someone might construct an intermediate hermaphrodite connector, and via that try to read the codes as they are being generated.

The means of copying the bit streams across the coding link 3 can provide a high degree of security against this. Clearly only half of the security codes needs to cross the coding link 3 in either direction. In the simplest form, device 1 could generate bytes for even byte addresses and device 2 could generate them for odd addresses. However this provides little or no security because they are coming out in a known order and so acquiring a third copy of all the codes is simple.

However in the case that the devices 1, 2 are made in pairs or sets, then they can have internally stored maps (which might be tables of numbers, coded algorithms, or a combination) that are effective at placing the random codes that are being generated and transferred across the interface at randomized positions in memory, where this randomization is common to a pair or set, but different between pairs and sets. Since every byte or word that is written to a location specified by the active memory pointer, this process can be considered as a randomization of the memory pointers. Such a process means that the numbers transferred across the coding link 3 have almost no relation to the code tables that will be read out of memory, but both code tables will be identical.

A worked example of this process is given below.

Table 1 shows the map held by each device.

TABLE 1

| | | | | | | | |
|---|---|---|---|---|---|---|---|
| Register | 1 | 2 | 3 | . . . | N | . . . | M |
| Value | | | | | | | |
| Memory | P₁ | P₂ | P₃ | . . . | P_{N} | . . . | P_{M} |
| Position | | | | | | | |

The data flow between device A and B is then as follows:
device flow from A to B: D₁^{AB}, D₂^{AB}, D₃^{AB}, . . . D_{N}^{AB}
device flow from B to A: D₁^{BA}, D₂^{BA}, D₃^{BA}, . . . D_{N}^{BA}
   where Dᵢ^{AB} is the i^{th} bit of data transferred from device A to device B, and Dᵢ^{BA} is the ith bit of data transferred from device B to device A.

The first byte of data is then constructed from D₁^{AB}, D₂^{AB}, D₃^{AB}, D₄^{AB} (which constitute even bits 2,4,6,8 of the first byte of data) and D₁^{BA}, D₂^{BA}, D₃^{BA}, D₄^{BA} (which constitute odd bits 1,3,5,7 of the first byte of data). After the first byte of data had been constructed in each device, then it is written to a memory position P₁. This process is then repeated for the second, third bytes etc. using memory positions P₂, P₃ etc.

It can be seen that the register value increments steadily but that the locations at which each sequential random code is stored have little or no relationship to each other due to the address randomization process.

Code Table Overwrite

As each block is finished, the two processors can generate and exchange checksum data. Such checksums can be constructed so as to ensure to enormously high statistical certainty that the code tables are identical, but without revealing anything of any statistical significance about the tables themselves.

As described above, two or more identical code tables are stored in two or more of these devices. As soon as they are unplugged from each other, they can be taken to different places and used as described below.

In all the different types of usage the fundamental mode of operation will be the same, and intrinsic to this fundamental mode is a further “code table overwrite” security feature discussed in this section.

As described above, the microprocessor 11 manipulates and stores a memory pointer, or multiple memory pointers. The purpose of multiple pointers will be described later and thus the general case can be described in terms of a single memory pointer.

Immediately after a coding operation the memory pointer in both devices in a pair, or all devices in a set, will be set to a common point in the memory map. Presuming that codes will be used up by incrementing continually upward in memory, in the general case the first code to be used will reside at the bottom of the memory, and so this common point is simply the lowest address in the memory, for instance 00000000H (in hexadecimal notation). The same principles as will be described below apply to different memory addressing schemes in an equivalent way. Thus at the end of a coding operation the memory pointer points at the next random code that is to be used.

This memory pointer is considered to be public information, not subject to security. So, if one device is now connected to a computer via the USB cable, there can be an open exchange in either direction as to what this memory pointer is set to, and in many circumstances the program running in the computer will be able to change the value of this memory pointer to point elsewhere.

However, a rule of the system is that whenever there is a request to release the random code that is pointed at by the current value set in the memory pointer in the microprocessor then it will be fetched and transferred to the computer, but the location within memory will immediately be over-written with a number from the random number generator, and the memory pointer will be immediately incremented (or otherwise changed) to point at the next random code in the table that is to be used. Since this number can only be transferred once across the USB (or other) communications port, then it cannot be stolen without being detected. Someone improperly removing the device and reading the code table could obtain the code table, but it would immediately be overwritten in the device. Even if the ‘thief’ were to return the memory pointer to original position, the theft would still be detected because the codes would now not match those in the pair device.

Such a ‘one-time-only-readable’ feature is powerful because it ensures that all thefts of a table are bound to be found out, but they do not help to detect a theft at the time that it is taking place, or close to the time it took place. Of course all such detections rely on the security procedures operated by the legitimate user, and no security breach can take place if the devices are never out of the legitimate users' control.

Additional features can be added to help with this, as described below.

Multiple Memory Pointers

The use of multiple memory pointers allows greater flexibility in operation, and several scenarios can be described which illustrate this use. It should also be understood that at any one time only one memory pointer is active, and thus the term ‘multiple memory pointers’ actually means copies of more than one value stored in non-volatile memory, one of which is made active at any time.

The first instance of use is where two users are using a pair of devices to encode and thus protect the security of documents. It is possible that the encoded documents may be sent by different means (for instance one by email and another by a floppy disc in the post) and so the order of generation and arrival may not be the same. The memory pointer is however public information, and the sender of the documents will thus be sending this to the recipient. If the recipient gets them out of order, then he/she or the computer program they are using will see that the first document received requires a memory pointer ahead of the current location in order to read the document. The computer program can thus record the current memory pointer position, in effect as a bookmark for later, then move the active memory pointer to the value required by the document, which can then be correctly decoded. This will leave intact in the recipient's memory the random code tables necessary to decode the first encoded document, as and when it is received. Clearly multiple such book mark values might be used.

In a second example, imagine a set of these devices. The general case will be that not all document transfers or authorizations will be with all holders of a device in the set, that the volume of activity with any other holder will not be known at the time of generating the table, and that the total volume of codes is comfortably in excess of needs. Therefore each user could allocate blocks of the total code table, in co-operation with each other holder of a device, so that there was a memory pointer and block allocated to each sender of information: in this scenario every member would be able to communicate with every other without needing to agree on which memory block to use at the time of initiating any message, and the blocks of codes necessary to decode a message from any sender will remain unused for any other purpose.

Password

A simple password is stored in each device 1,2, which the user has to program and then maintain as secure. Again this is a feature that can be fooled if an illegitimate user acquires the password.

Checksum

A very powerful feature is to allow the user to request, at any time, a list of the block checksums, or the master checksum for the whole memory. Note that the term ‘checksum’ is used herein to refer to the result of any algorithmic process which reads the value of all of the elements of the ‘random’ code tables or a specified block of a code table, in which the checksum for a block is a signature characteristic of that block and statistically enormously unlikely to be generated for another block with different content, and thus is a reliable guide as to whether a block remains unchanged, and that it is different from another block, without these checksums revealing anything statistically meaningful about the blocks. Someone armed with the checksum algorithm AND the checksum for a block must need an unreasonably large amount of time on a computer to try to construct the random code block by trial and error using the checksum as a test.

If the user knows that the checksum has remained unchanged, and that the read-once feature would change the checksum if the code block had been improperly read, this gives a very high order of security.

Re-Coding

The checksum feature can also be used to shorten the re-coding time. Mass memory (FLASH) these days is so cheap that very large blocks could be implemented in these devices cost effectively, and it is natural for the user to want the biggest block. However most people will routinely be using up these codes at a far lower rate, and so when the opportunity arises to re-code with the device pair it is most likely that not all of the code table will have been used. By transferring and comparing these checksums, starting from the top of memory, it will be very simply possible to establish how much has been used up, and that what is left is secure.

The devices then need only to set up to re-code from the bottom of the code space to where the old codes are still in place.

Post-Coding

The sections below describe the various applications and additional security measures which may be employed after the coding steps described above.

One Time Pad

A pair of devices, made as a pair, provide a very high degree of security, and, unless that security is physically compromised, the owners of this pair, using ‘one-time-pad’ encoding can have completely secure communication of messages sent between themselves.

An example of such a secure communication is shown in FIG. 8. The first device 1 is coupled to a first computer 30 which encodes a message using part of the code table as a key. The key is then overwritten in the first device. The encoded message is transmitted over a communication link 31 to a second computer 32 where it is decoded using the same key stored on the second device. The key in the second device is then overwritten.

Financial Transactions and Trusted Partners

In general the need is to communicate between any two parties, and in addition to be able to authorize transactions and payment. Therefore a secure and acceptable procedure for the general public would be that one device of a pair was held by a trusted partner, such as a bank. Payments and other financial transactions would be possible with the bank itself, but it could also allow secure communications if the bank uses and maintains secure communications with the ‘trusted partner’ of the desired recipient of the communication. This second trusted partner could then use the same principle to transfer the communication to this recipient, using the recipient's paired code table.

As a further measure, very long device identity numbers might be placed in one-time-programmable code or i.d. space within the processors, and it might be that regulations were applied, and executed as part of the operating code of these devices that required that these i.d. numbers were sent as the headers of all communications or authorizations. Whilst no direct loss of user privacy would result, it would allow authorities to readily identify suspect communications and use other means to locate the parties in communication. Such ‘very long number’ identifications would be taken from a ‘sparse’ set, ie one in which very few of all possible numbers were ever used, and the list of id codes issued would be supplied to national governments at the time of manufacture. Thus it would be practically impossible for an individual or unrecognized manufacturer to choose codes that would not be recognized as unauthorized. Stealing and using existing codes would of course be possible, but of very little use, because the transmissions would still be recognizable, and the codes of devices that were physically stolen could be removed from the authorized list. Transmissions without such codes would equally be very soon recognized, and in any case are possible at present by anyone understanding the technology.

There is still very considerable advantage to having the two distinct parts of the coding device, because all of the codes are held in a one time readable form until needed and simply not available to unauthorized users as would be the case if transferred to standard storage media. Thus banks of discrete pair devices in racks, all permanently connected through a multi-port communications network, would allow a bank to enjoy the same high security against theft, combined with automatic reading. However it is also possible to conceive that large trusted organizations could have readers or interfaces in which a port emulated the other device of a pair, and the code sequences were indeed stored in a conventional sense on a computer.

Such codes can be used in a financial transaction in a number of ways, and the following is not an exhaustive list.

Electronic Signature in Financial Transaction

Firstly the codes can simply used as an electronic signature to authorize a conventional payment means. In the simplest example of a retail purchase, the user's device would pass a code from its list, and its memory pointer value to a ‘point of sale terminal’ or similar device. This would pass the code up to the bank holding the user's account and the second copy of the code list. In the case of a legitimate transaction the bank would recognize a match, the thus authorize the purchase.

Whilst this simple transaction is the essence of such payment, other code transfers might take place to enhance security. Firstly there might be a code transfer from the bank to the user, to verify that the vendor's POS terminal was indeed connected through to the bank. Immediately after the ‘payment authorization’ code had been transferred from user to bank and authorized, the bank might respond with a further code (which only the user could recognize), and the bank might encode a message to the user using a further set of codes (in the communications encoding mode) that would verify to the user that the transaction had indeed taken place (and this communication would be impossible for a third party to falsely generate). The bank and the vendor might also share a code set which could be used by the bank to verify that the transaction was indeed legitimate.

Clearly closely parallel means could be used to authorize the other forms of transaction, financial or otherwise.

Despite the code exchange described above, there will still be means by which a criminal user of POS devices might try to defraud the user: for instance in a restaurant it would be conceivable that a user, believing they were paying by this means for a meal, might not be charged for the meal, but that the POS might be tampered with to divert the code sequence to authorize a very much larger transaction, for instance a transfer of money.

A further enhancement will now be described which would be effective at preventing such fraud. In this enhancement the devices 1, 2 are additionally equipped with a visual display device and a few input keys, or other form of input device. The additional security features use the device and its pair at the bank or trusted third party additionally in the communications mode. For instance the vendor or POS could be responsible for passing the details of the transaction to the bank, but the bank could use the encoding mode to send these details back to the display on the user's device, so that the user could see the transaction being proposed. Since only the user and the bank share the code tables that allow this communication, any form of tampering with communications will fail. A large number of permutations of transmissions are possible, but the following is an example of an exchange which considerably enhances security.
1) The user identifies him/herself to the bank with public information.
2) The user sends the next code on his list and his current memory pointer value. Both should match, but if for instance there were previous lost transactions or transmission route delays the bank might be allowed to work from the memory pointer location given, not the last it had (which it would have to book-mark).
3) The bank sends the next code back to verify that it is indeed on line and that there is no detectable compromise of security on the communications line.
4) The vendor or POS would then send the transaction details (amount, details) to the bank in ‘open’ form.
5) The bank would reply with another code that showed that it was online, and then a message for the user device, using the encoded mode, which could replay the transaction that was about to be effected.
6) The user could then send a first signature code and a message returning a confirmation of the transaction to be made in the encoded form.
7) The bank could then reply with a final code and encoded message confirming that everything had been transacted.

It will be seen that in this transaction it is the usage of a visual display device which is an intrinsic part of the user's device that effects this greater level of security because it is simply not possible for the vendor to tamper with data sent through the encoded mode, and it is the physical integrity of visual display with the user device that ensures to the user that falsely re-assuring messages are not fraudulently substituted. Thus it can be seen that this level of security could also be obtained by using a device without a visual display if it were coupled by the user to another trusted device, such as the user's mobile phone or PDA.

Electronic Cash

There are also circumstances in which an electronic analogue of cash would be useful, such as when users do not have, or do not wish to have banking or credit facilities, or indeed when the user wants the anonymity that physical cash provides.

If very long numbers are used as authorization codes, then numbers which are trivially manageable by computer and electronics technology can be so large that, in the whole estimated life of usage of the proposed system, it becomes extraordinarily unlikely that the same long number will ever appear twice. Moreover, since these numbers are truly random, and the ‘average’ spacing between any two so huge, knowledge of one number gives no clue as to knowledge of another. Thus someone holding a matching code list and receiving such a code and its corresponding memory pointer from a remote party is going to know that that code was indeed sent by the sending party's device.

The size that numbers need to be to have these properties is relatively simply estimated. The world's population is of the order of 10ˆ10, and annual per-capita income of the order or less than 10⁴ US dollars. Cent denominations would require another factor of 100, and operation for a thousand years another factor 1000.

Thus all the trade in the world could be done in single cents for 1000 years with numbers of the order 10⁹. This is just a little less than 64 bits in binary representation. Use of a number twice as long, i.e. 128 bits or 16 bytes gives an extraordinary excess of codes, but the length to an electronic system is trivial: clearly use of 128 bit numbers is by way of example, and not prescriptive.

The use of the devices for the storage and use of ‘electronic cash’ can be conceived in many ways. The user and the ‘trusted partner’ might first generate the two copies of the random long code numbers. The user might then go to the ‘trusted partner, particularly if that partner was a bank, and might buy a block of cash (to a certain value) in a selection of denominations, and those denominations would be stored in another part of memory with some known relationship to the long number codes, so that each code had a denomination. The relationship between the code and its denomination would be known to the user and to the bank.

Referring to FIG. 9, the user, wanting to make a purchase, plugs or otherwise connects the device 1 into a point of sale (POS) device 40, and enters the value of the purchase into the point of sale device 40. The device 1 then algorithmically chooses a set of long number codes that adds up to the correct amount. The device 1 then transfers these codes, plus an identifier for the issuing bank and one for the user, to the POS device 40. The POS 40 now knows which bank to contact to gain payment authorization, and transmits these long number codes to the bank computer 41 over a communication link 42.

Note that even over a massive range of values it seldom takes more than ten such electronic ‘coins’ to make up any given amount of money, if the denomination goes up in the familiar 1c, 2c, 5c, 10, 20c, 50c, $1, $2, $5 . . . sequence). The POS device 40 does not at this time need to know the denominations. The bank computer 41 however does, and so when looking up these codes in the user list it can reconstruct the cost that is to be charged, and transmit this back to the POS device 40. Clearly the two amounts should match. The bank computer 40 can then credit the vendor with the amount, and both vendor and bank can record the codes for audit purposes, but mark them as spent.

The above explanation simplifies things a little by assuming that the vendor and the user have the same bank, but it is clear that the bank who issued the electronic cash can make a normal banking transfer to the vendor's account at another time.

In this transaction the user's i.d. is known to the vendor and to the bank. However there are circumstances where buyers want the anonymity of cash.

This can be achieved with this technology in a slightly different way. Here the issuing bank would take the set of codes generated with the user, and transfer them to a master table in which all such long codes from many users could be stored. Once in this table the bank has no need to know the ‘owner’ of any of these long codes, and if the user can trust the bank in this respect then anonymity can be obtained.

The bank computer 41 must then sort these long codes into number order, and put them in a table in which each long code is associated with its assigned denomination (here it must be understood that very long numbers can be relatively easily compared and moved, and so standard sort algorithms are efficient). The difference in value between two adjacent numbers will however be vast.

When a set of long number codes are received from the POS device 40 vendor, then the bank computer 41 can very quickly establish whether the offered long number is in the table, and if it is, what its monetary denomination is. Here one technique which would be efficient would be a binary search algorithm. The bank computer 41 would first look at the value in the middle of the table, and compare this to the offered number. If the offered number is lower than the number found, then the computer would then look in the middle of the lower half of the table, if higher then it would then look in the middle of the upper half of the table. Clearly this process can be repeated, and it takes relatively few such comparisons to find the number, or the nearest number. If it finds the number, then it is a match, if however it finds two adjacent numbers that bracket the value of the offered code, then it is certain that there is no match, and that the offered code is invalid.

Long number code entries that matched could then be removed from the table, and placed into a simple audit trail sequence, to show that the cash value had been spent.

Local Area Information System

In an alternative application, the invention may be implemented in a local area information system of the type described in WO 01/27897. That is, the local area information system comprises a network of base stations, each having a memory for storing information relating to the local area; and a plurality of user devices for receiving the information from the base stations and presenting the information to a user.

Each base station, and each device with which it is in wireless communication (be it a user device or another base station) can apply “one time pad” encoding to the communication (using devices as described herein) to reduce the chance of the communication being intercepted and understood, and can use the long number mode as authorizations for transactions or to test and maintain security of communications links.

Alternative Embodiments

Device Sets

In the preferred embodiment described above, the devices are made in pairs. In an alternative embodiment the devices might be made in authorized sets, and so instead of holding the details of one allowed pair device, they would hold a list of such devices.

Generic Unpaired Code Devices

Instead of being manufactured in pairs or sets, in a further alternative embodiment each device may be a Generic Unpaired Code Device (GUCD) which is not associated with any other device or set of devices. In this case, each GUCD would be coded so as to have authority to work with any other compatible device.

This presents additional security challenges because it has to be expected that the GUCD will be reverse engineered by someone. So someone understanding a generic algorithm for mapping the random bit stream into memory will be able to make that mapping themselves, and so obtain a third copy. He/she would even be able to generate the checksums and compare them to those passed by the two coding devices to ensure that the third copy was correct.

It should be noted however that this level of security breach is only possible if someone improperly sets up a ‘spying’ connection to the coding link 3. There will be commercial use for GUCDs. If they are used to a protocol there is no such risk. Therefore, for instance, if GUCDs were used in a mode in which one half of a pair of co-coded devices were held by trusted third parties, such as the banks or postal service, there would be no such risk.

Furthermore, if a secure phase was possible by ensuring correct operation, a further option is possible. Two or more GUCDs could be made into a ‘virtual set’. They would be connected together via their coding ports, either directly or with a special adaptor, and they would generate and store for future use a unique bit placement map or algorithm, that was statistically most unlikely to be in use with any other set. The only difference between this ‘virtual’ set, and a set made as a set at manufacture, is that this bit placement process would be stored in non-volatile memory (again preferably the top of the FLASH memory), and would not be able to take advantage of the slightly higher security of encoding some of the uniqueness into the microprocessor calibration or ID space, which is normally ‘one time programmable’ (in the manner of a fuse).

It should be noted that this ‘virtual pair’ coding operation, which is generating the bit placement map, needs to happen only once to a pair or set. Thus, trusted third parties could buy such devices in bulk, and code them as pairs or sets as needed. This operation can clearly be achieved to a higher level of operational protocol and security with a large organization, and so there is considerably less risk than there is to the code generating operations, which may be done routinely by individuals in all sorts of circumstances.

Random Number Generator

In the preferred embodiment each device has a random number generator. However in a first alternative embodiment only one device might have the random number generator. In a second alternative embodiment neither device may have a random number generator. In this case, the random number generator will be held in a third device.

USB Power Supply

In the preferred embodiments described above, power supply during coding is via the battery cells 15. In an alternative embodiment shown in FIG. 10, during the generation of code tables the USB port 14 of one of the devices may be plugged into a computer 50 to derive power for both devices. In this mode, the computer may run a driver program which reports actions and options to the user via a display screen 51.

Whilst it is common that USB mass storage devices appear as computer ‘Drives’, this is not a requirement of the standard, and the device would identify itself to the computer as a specific and new sort of device, with its own ‘driver’ software package that would need to be loaded before operation.

Alternatives to USB Port

The USB standard is given here as an example, and the device would work with other common serial computer standards such as RS485, RS232, RS422, RS423, IEEE1394 (Firewire) and even (but not conveniently) parallel standards such as PCMIA and the ‘Centronics’ printer port. USB is convenient in terms of its communication standard and because it supplies power over the interface to power devices so attached. If another sort of interface was used, then a power supply would also be needed.

External Battery Pack

In the preferred embodiments described above, power supply is via the USB port 14 or the battery cells 15. In an alternative embodiment, one or both devices might have an input for an external battery pack, mains power supply or vehicle supply adaptor so as to provide power for the pair.

Coding Link

In the preferred embodiment described above, the coding link 3 is established between dedicated coding ports 13, 14. In an alternative embodiment, the coding link can be established over the USB port 14 using an adaptor that would allow them to plug together.

Male/Female Coding Ports

In a further alternative the coding ports may me made either in pairs, or in two genders, so that a male device and a female device might be connected for coding purposes, whereas male to male and female to female connection would not be possible.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention.

Network Communications

The present invention may advantageously aid in conducting secure transactions in a communications network such as described in applicant's co-pending U.S. patent application Ser. No. ______ claiming the benefit of corresponding European Patent Application No. EP05252251.3 entitled “A Communications Network” filed Apr. 11, 2005 [attorney docket 19143], the whole contents and disclosure of which is incorporated by reference as if fully set forth herein. The network, as described in co-pending U.S. patent application Ser. No. ______, enables entities to host (locally cache) data content at one or more nodes, a plurality of nodes forming a cluster, with at least one node back haul connected to a network such as the Internet. Users may, through their conventional mobile and hand-held wireless devices (implementing Bluetooth, WiFi 802.11 protocols, for example), initiate the downloading of content from a node or node cluster to the user device, or receive Internet based services via the user device. In one embodiment, the user devices are furnished at manufacture (i.e., stored in erasable memory) or may be furnished as an add-on card or attachment (flash card, USB key, RFID, Bluetooth, for example) with a list of random codes, e.g., on the order of a billion “large” numbers (e.g., 128 digit codes (base 10)). These codes are additionally maintained by a verification service accessible by the network server device at the node or cluster in the network. The verification service maintains a registry of subscribing users and the list of random codes associated with that user's device. Additionally associated with each user is a predetermined service level that a user has subscribed to for transacting within the network. Subsequently, when a user initiates a wireless transaction with a node in the network, the large number code is wirelessly transmitted to the server which accesses the verification service to verify that the user device that is communicating is authorized to conduct a particular transaction. The random code may be either transmitted in the subsequent communication, or used as an encoding key in the subsequent communication. In response, the server can verify the particular device with each code associated with a device and device owner (user). Additional transaction authorization is provided to ensure the operator of the device is indeed the owner of the device (or at least the authorized user). This further authentication may be implemented by requiring a user to enter a PIN (ID number) or provide biometric data, which may be used to verify that the user/device is authorized to conduct a transaction with a host node.

In one particular embodiment, large number codes (or a subset thereof) may be stored in a passive chip embedded in a (ubiquitous) “UBI” card utilized for conducting transactions with a host. Should a consumer wish to purchase any product or, download content from a node, they would simply depress the keypads on the card in the proper sequence to pass final authentication. One of the random codes is transmitted for each transaction as part of a financial transaction (one random code at a time) and erased or removed from the memory after completion of the transaction.

Once authentication is complete, the transaction is authorized and the purchase is simply deducted from a secure financial account associated with the consumer's UBI card in a similar fashion to credit card use today. Otherwise, the code is used as a key to endorse payment instructions with a digital signature. Further details regarding the UBI card structure is found in above-identified, co-pending U.S. patent application Ser. No. ______ [Attorney Docket 19143].

As the network itself may have low reliability components, e.g., analog channels that accommodate communications at microwave/RF frequencies, it is imperative to ensure the integrity that the random code is transmitted securely with a high degree of reliability, i.e., extremely low bit error rate (e.g., less that 1/10⁹). Thus, in the embodiment described, it is important to be able to communicate the 128 number code codes over the unreliable channels. To ensure reliable communications during the authentication and transaction processes, several existing networking techniques, well known to those skilled in the art of packet networking and packet communications, can be utilized. To ensure proper transfer and integrity of the random codes and authentication information, communication protocols that guarantee delivery (such as TCP or equivalent) are utilized. Utilizing these types or protocols, the random numbers and other authentication information are either delivered in their entirety, or the packets are retransmitted until they are delivered in their entirety. In the event that the information can not be delivered in its entirety, the sending fails and process can start over if desired. Once the random numbers and authentication information is successfully received, additional transaction processing techniques are utilized to ensure that the appropriate end to end transaction is completed (Debit matched to a Credit, as an example) as a “unit of work”. These techniques can easily be deployed, even over high bit error rate wireless connections, because the transmissions detailed here are carried out between two or more networked devices that each have the ability to acknowledge transmission and receipt of packets to the sending and receiving parties.

While the invention has been described herein with reference to specific embodiments, features and aspects, it will be recognized that the invention is not thus limited, but rather extends in utility to other modifications, variations, applications, and embodiments, and accordingly all such other modifications, variations, applications, and embodiments are to be regarded as being within the spirit and scope of the invention.

1. A method of communication comprising storing a random code in a first device; storing the random code in a second device; and using the random code in a subsequent communication.

2. A method according to claim 1 further comprising checking the identity of one of the devices; and only storing the random code in the device if its identity matches a stored identity.

3. A method according to claim 1 wherein the subsequent communication includes reading the random code from the first device; and automatically overwriting the random code in response to the reading of the random code whereby the random code in the first device can only be read once.

4. A method according to claim 1 further comprising generating all or part of the random code in the first device; and transferring the random code from the first device to the second device to enable the code generated in the first device to be stored in the second device.

5. A method according to claim 4 further comprising generating a first part of the random code in the first device; transferring the first part of the random code from the first device to the second device to enable the code generated in the first device to be stored in the second device; generating a second part of the random code in the second device; and transferring the second part of the random code from the second device to the first device to enable the code generated in the second device to be stored in the first device.

6. A method according to claim 1 further comprising storing a map in the first device and the second device; generating a plurality of random code elements; and storing each code element in each device at a memory location determined by the map.

7. A method according to claim 6 wherein the map identifies the memory locations directly.

8. A method according to claim 7 wherein the map is an algorithm enabling the memory locations to be calculated.

9. A method according to claim 1 further comprising generating first check data from the random code stored in the first device; generating second check data from the random code stored in the second device; and comparing the first and second check data.

10. A method according to claim 1 wherein one or both of the devices is portable.

11. A method according to claim 1 wherein the subsequent communication includes the step of transmitting a memory position indicator from the first device to the second device; and retrieving a random code element from a memory position in the second device which is determined by the received memory position indicator.

12. A device comprising a memory for storing a random code; and a processor for utilizing the random code in a subsequent communication.

13. A device according to claim 12 further comprising a hermaphrodite connector having one or more male plugs and one or more female sockets.

14. A device according to claim 12 further comprising a random number generator.

15. A device according to claim 12 further comprising an identity of a pair device hard coded into the device by a one time calibration write sequence.

16. A device according to claim 12 further comprising a display screen.

17. A device according to claim 12 further comprising a tamper-evident element which can indicate physical tampering of the device.

18. A device according to any of claim 12 further comprising a sensor for sensing physical tampering with the device.

19. A method of conducting a secure communication comprising the steps of:
a. transmitting a message;
b. receiving an encoded response to the message, the encoded response having been encoded using an encoding key;
c. decoding the encoded response using the encoding key to generate a decoded response;
d. validating the decoded response, and if the decoded response is valid, then;
e. transmitting a confirmation message.

20. A method according to claim 19 wherein the decoded response comprises a copy of the message transmitted in step a.

21. A method according to claim 19 or 20 wherein the confirmation message is an encoded message.
